(19) United States
(12) Patent Application Publication
(10) Pub. No.: US 2006/0089190 A1
(43) Pub. Date: Apr. 27, 2006

(54) Multi-game gaming machine

(76) Inventors: Natalie Bryant, Rosebery (AU); Martin Leach, Lane Cove (AU)

Correspondence Address: MORRISON & FOERSTER LLP, 755 PAGE MILL RD, PALO ALTO, CA, 94304-1018, US

(21) Appl. No.: 11/125,433

(22) Filed: May 9, 2005

Related U.S. Application Data
(63) Continuation of application No. 10/910,188, filed on Aug. 2, 2004.

(30) Foreign Application Priority Data
Aug. 6, 2003 (AU) 2003904141

(51) Int. Cl. A63F 13/00

(52) U.S. Cl. 463/20

(57) ABSTRACT

A multi-game gaming machine includes a gaming console having a first display means on which a simulation of a game can be displayed housed in the console and a second display means also housed in the console. A player input means and a control means are arranged in the console for controlling images displayed on the first video display means. The gaming machine is arranged to allow a player to select a game to be played on the gaming machine from a plurality of different games. The second video display unit displays information pertaining to the multi-game theme or advertisements for games playable on the machine displayed together or in sequence one after another, when the gaming machine is not being played and/or when no game has been selected, and when a game is selected, or played on the machine, the second video display unit displays at least second information associated with the selected game. The present invention provides significant advantages over existing multi-gaming machines. It allows individual games accessible within a multi-game gaming machine to be advertised in addition to the multi-game gaming machine itself so that the games do not lose their identity within the multi-game machine. At the same time, it provides players the ability to view game information whilst playing the game.

### FIELD OF THE INVENTION

This invention relates to a gaming machine. More particularly, the invention relates to a gaming machine and to an improvement to such a gaming machine.

### BACKGROUND OF THE INVENTION

Players who regularly play gaming machines quickly tire of particular games and therefore it is necessary for manufacturers of these machines to develop innovative game features which add interest to the games. In so doing, it is hoped to keep players amused and therefore willing to continue playing the game as well as to-attract new players.

Also, with the growth that has occurred in the gaming machine market, there is intense competition between manufacturers to supply various existing and new venues. When selecting a supplier of gaming machines, the operator of a venue will often pay close attention to the popularity of various games their patrons. Therefore, gaming machine manufacturers are keen to devise games and/or features which are popular with the players as a mechanism for improving sales, retaining customers and attracting new customers.

“Multi-game” gaming machines are gaming machines that are capable of playing a number of games and allow a player to select a game they wish to play from a range of available games. When the gaming machine is not being played, the gaming machine's video screen displays a game selection screen offering a range of available games that the player can choose from. The gaming machine's art work is generally generic and usually only indicates that the game machine is a multi-game gaming machine.

Whilst multi-game gaming machines have an advantage over gaming machines which play only a single game in terms of enabling a smaller number of machines to provide a greater range of games so that a player is more likely to be able to locate the game which they prefer playing or wish to play, they have the disadvantage that the individual games played on the machine tend to lose their identity to the multi-game theme. Therefore, players cannot look at a bank of machines from across a club and see their favourite games. Instead, they see a multi-game theme and then have to look closely at the video screen to see what games are provided on that multi-game machine. Hence, operators are disadvantaged by not being able to advertise the games that the players may wish to play.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

### SUMMARY OF THE INVENTION

According to the present invention, there is provided a gaming machine which includes:

a gaming console;

a first display means on which a game can be displayed housed in the console;

a second display means also housed in the console;

a player input means and a control means arranged in the console for controlling images displayed on the first video display means;

wherein the gaming machine is arranged to allow a player to select a game to be played on the gaming machine from a plurality of different games, characterised in that the second display means displays first information when the gaming machine is not being played and/or when no game has been selected, and wherein when a game is selected, or played on the machine, the second display means will display at least second information associated with the selected game.

Typically the first information will be generic information or information pertaining to multi-game theme or will be advertisements for games playable on the machine displayed together or in sequence one after another,

In one embodiment, the second information displayed on the second video display means, is an advertisement (the “attract display”) for the applicable game and the pay table and game information for playing the selected game are shown on a help screen displayed on the first display means.

Preferably though, the second information displayed on the second display means is a the pay table and game information for the selected game. This display will preferably remain on the second display means for the duration of play of the selected game.

Alternatively, there may be special feature events, that are displayed on the second display means occurring during game play which temporarily replace the pay table information.

Typically the bet buttons are displayed as touch screen icons on the first display means.

Preferably functions that remain consistent in the different games such as PLAY, GAMBLE, TAKE WIN, COLLECT, RESERVE, GAME RULES and GAME MENU, are provided on mechanical buttons, typically on the mid-trim of the machine

All remaining game information that is not shown on the second display means, preferably appears on help screens that can be accessed in place of the game screen on the first display when the player presses the mechanical GAME RULES button.

### BRIEF DESCRIPTION OF THE DRAWINGS

The invention will now be described, by way of example only, and with reference to the accompanying drawings in which:

FIG. 1 shows a perspective view of a multi-game gaming machine incorporating a secondary display screen in accordance with a first embodiment of the invention;

FIG. 2 shows a schematic, block diagram of a control circuit of the gaming machine of FIG. 1;

FIG. 3 shows generic artwork for a gaming machine in accordance with an embodiment of the invention;

FIG. 4 shows a game display appearing on a main video screen of the gaming machine of FIG. 1;

FIGS. 5 to 7 are exemplary advertisements for different games offered on the machine which may appear on secondary screen of the gaming machine of FIG. 1;

FIG. 8 shows an example of a main display which may appear on the main display of the gaming machine;

FIG. 9 is a schematic diagram of a mid-trim of the gaming machine shown in FIG. 1;

FIG. 10 illustrates a display of a pay table for a game being played on the gaming machine;

FIG. 11 and FIG. 12 show displays of rules for a game being played on the gaming machine;

FIG. 13 shows a exemplary display which appears on the main screen of the gaming machine following the selection of a different bet option to that selected for FIG. 8;

FIG. 14 shows the associated dynamic associated pay table which appears when the different bet option is selected; and

FIG. 15 is a flow chart setting out the operation of the gaming machine.

### DETAILED DESCRIPTION OF A PREFERRED EMBODIMENT

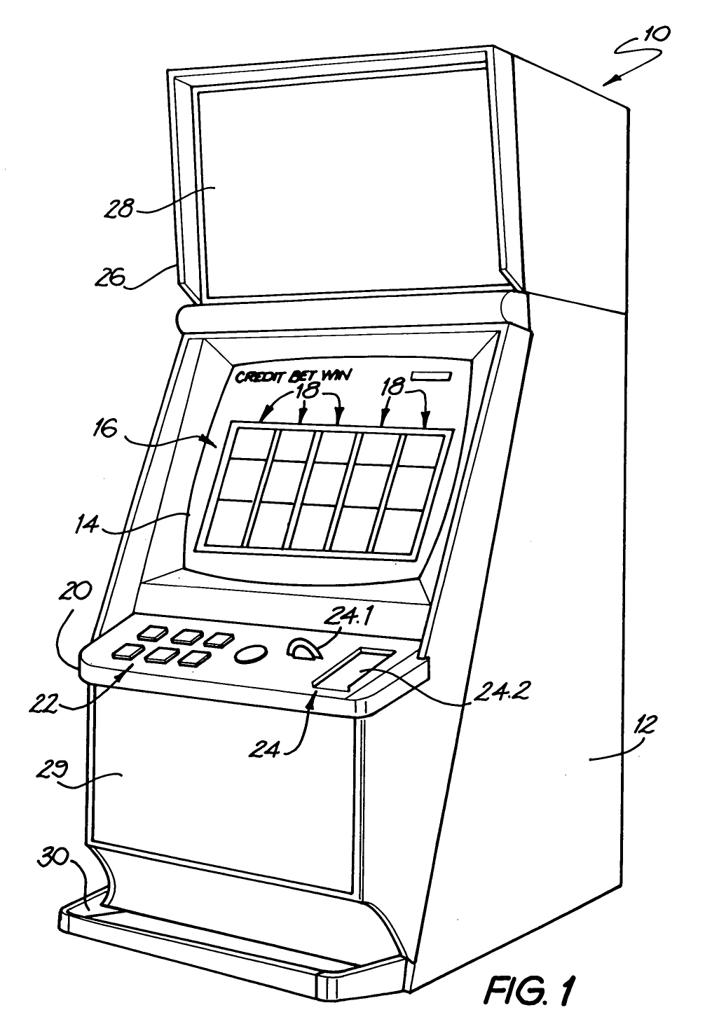

Referring to the drawings, in FIG. 1, reference number 10 generally designates a gaming machine, embodying the invention. The machine 10 includes a console 12 having a first or main display means in the form of a video display unit 14 on which a game 16 is played, in use. The video display unit 14 may be implemented as a cathode ray screen device, a liquid crystal display, a plasma screen, or the like, The game 16 is a spinning reel game which simulates the rotation of a number of spinning reels 18. A mid-trim 20 of the machine 10 houses a bank 22 of buttons for enabling a player to play the game 16. The mid-trim 20 also houses a credit input mechanism 24 including a coin input chute 24.1 and a bill collector 24.2.

The machine 10 includes a top box 26 on which a second or secondary display means in the form of a video display unit, most preferably an LCD display 28 is carried. The display may, for example, show advertisements, pay tables, or details of bonus awards, as is described in more detail below.

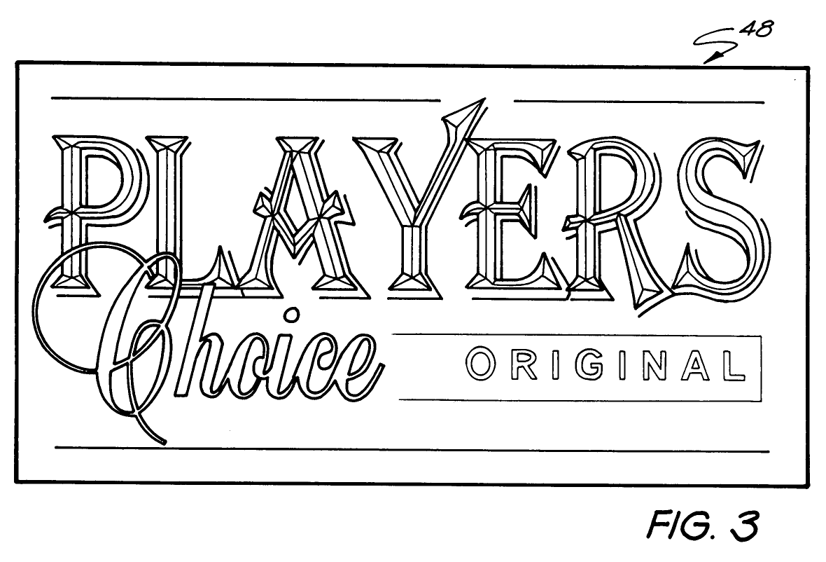

The belly 29 of the gaming machine displays artwork which is shown in more detail in FIG. 3.

A coin tray 30 is mounted beneath the console 12 for cash payouts from the machine 10.

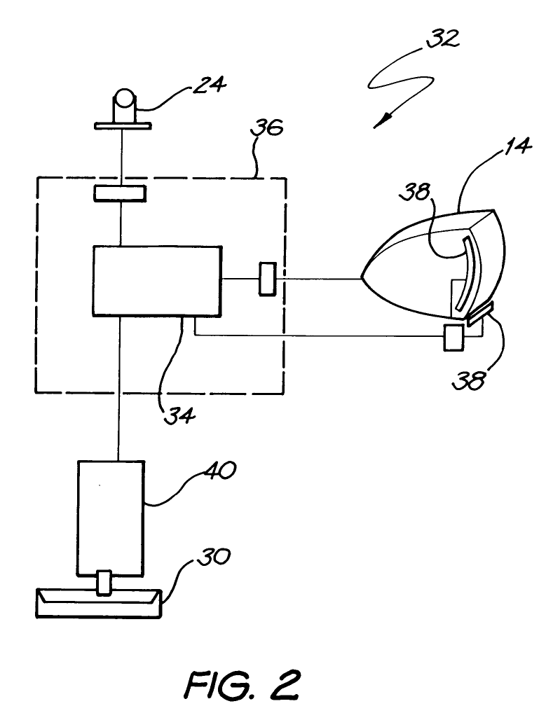

Referring to FIG. 2 of the drawings, a control means or control circuit 32 is illustrated. A program which implements the game and user interface is run on a processor 34 of the control circuit 32. The processor 34 forms part of a controller 36 that drives the screen of the video display unit 14 and that receives input signals from sensors 38. The sensors 38 include sensors associated with the bank 22 of buttons and touch sensors mounted in the screen of the video display unit 14. The controller 36 also receives input pulses from the mechanism 24 to determine whether or not a player has provided sufficient credit to commence playing. The mechanism 24 may, instead of the coin input chute 24.1 or the bill collector 24.2, or in addition thereto, be a credit card reader (not shown) or any other type of validation device.

Finally, the controller 36 drives a payout mechanism 40 which, for example, may be a coin hopper for feeding coins to the coin tray 30 to make a payout to a player when the player wishes to redeem his or her credits.

FIG. 3 shows the artwork 48 which is displayed on the belly of the gaming machine which is static generic multi-game artwork as is generally required in order to identify the gaming machine in most jurisdictions. Because of the position of the belly artwork and the way gaming machines are generally arranged in venues, the belly of a gaming machine is not usually particularly noticeable and artwork located in the belly of a gaming machine is not usually responsible for initially attracting a potential player to a particular machine.

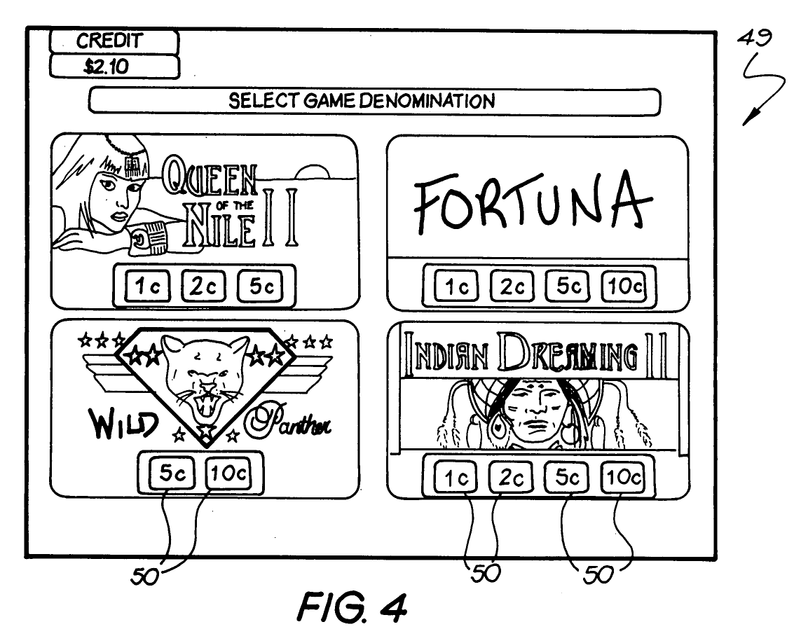

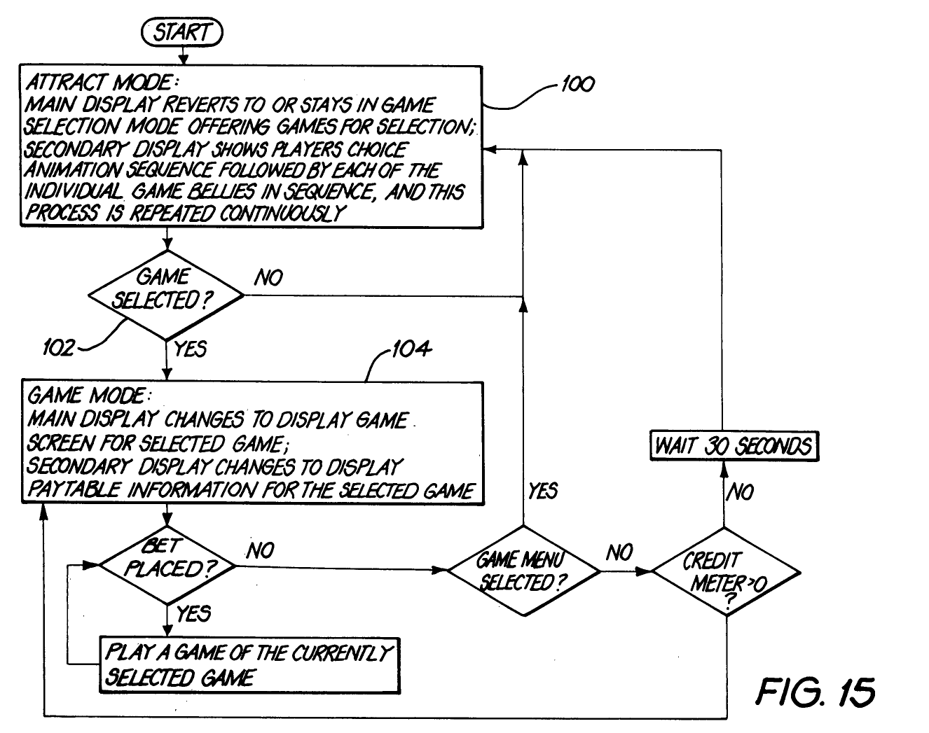

The gaming machine 10 is configured to be able to play a plurality of games, typically, at least ten. A flow chart setting out the operation of the game is set out in FIG. 15. The player chooses the game (box 102) that they wish to play on the gaming machine from a menu, displayed on a game selection screen on the main display 14. One example of a game selection screen 49 is shown in FIG. 4 which offers four games, “Queen of the Nile II”, “Fortuna”, Wild Panther” and “Indian Dreaming II” and for each game, discloses a series of denomination button icons 50 for each game, each denomination button icon indicating the value of a single credit for the applicable game. By touching one of the button icons, the player will be able to select the desired denomination of the game applicable to the associated game image. While in the game selection mode shown in FIG. 4, generic multi-game art is displayed on the secondary display 28. This may be a static video representation of the same artwork 48 that appears in the belly of the gaming machine as shown in FIG. 3.

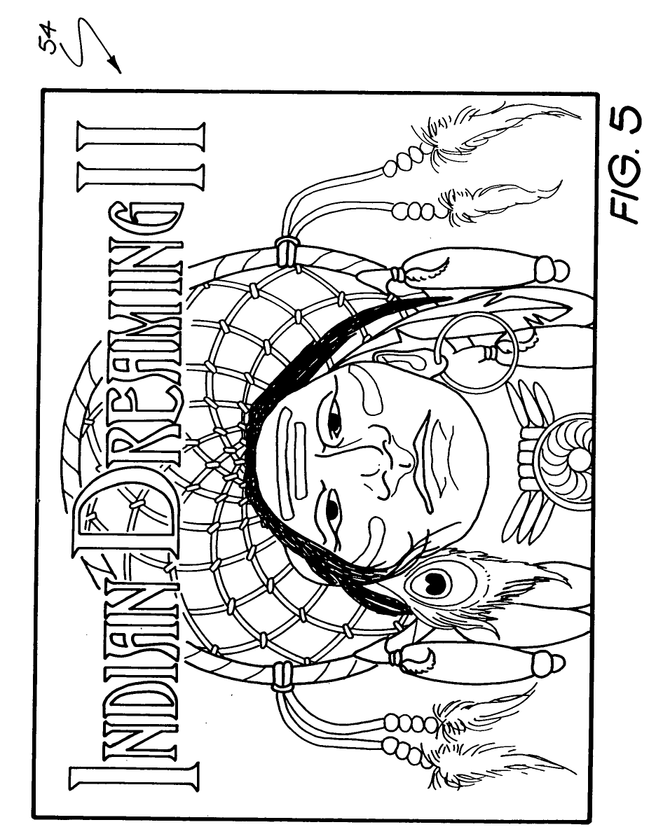

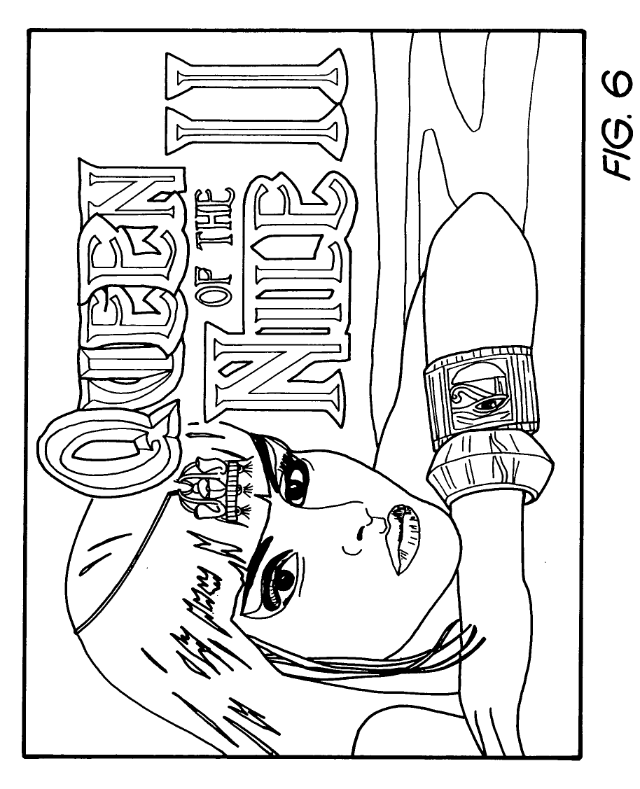

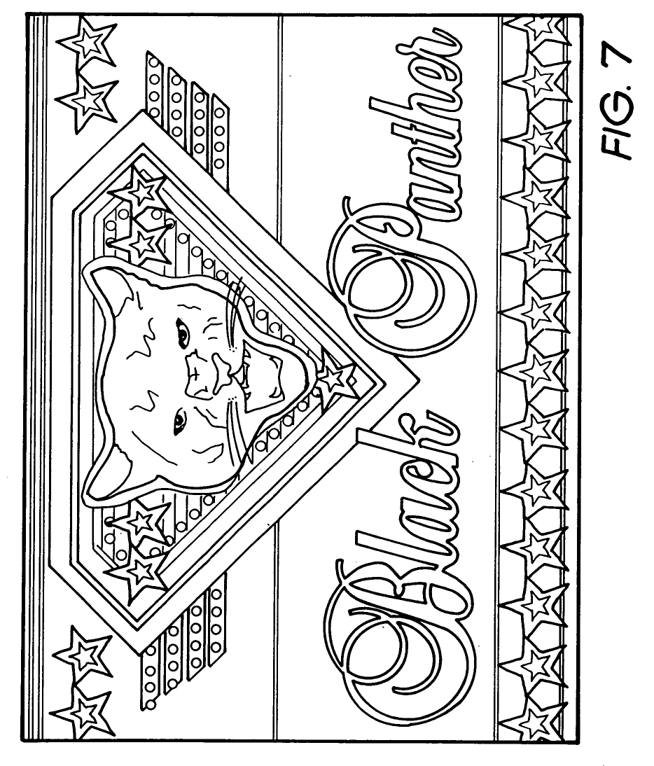

When the machine has zero credits registered on its credit meter, it automatically reverts to the game selection screen 49 on the main display if it is not already being displayed (box 100 - FIG. 15). The machine will then seek to attract potential players by commencing an animated sequence on the secondary display 28, referred to as an “attract mode”. The animated sequence commences with generic multi-game artwork shown in FIG. 3 and then cycles through a series of advertisements for the different games that are offered on the machine. Examples of how some of those advertisements might look are shown in FIGS. 5 to 7. Because of the predominant position of the secondary display means on the top box of the gaming machine, the attract mode will serve the purpose of advertising the different available games to potential players within the venue. Hence, although the machine is a multi-gaming machine, the games that are available on the gaming machine will still be clear to potential players, even from a distance. If the games are changed or updated in the gaming machine's software, the attract mode sequence will also be updated accordingly, and therefore potential players will be immediately aware that new games are present when they look at the machine.

Returning to FIG. 4, when the player touches one of the denomination buttons 50 on the game selection screen, the main display will change to the game screen applicable to the selected game, and at the same time, the secondary display will change to apply solely to the selected game shown in FIG. I (box 104 - FIG. 15). In one embodiment, the secondary display shows the attract display for the applicable game, An example of the attract display for “INDIAN DREAMING” 54 is shown in FIG. 5. If the secondary display, does display the attract display for the applicable game, the pay table and game information for playing the selected game will be shown on a help screen displayed on the main display means. Preferably though, the secondary display will show the pay table and game information for the selected game. This display will preferably remain on the secondary display for the duration of play of the selected game. The pay table may be dynamic in which case it will change slightly as games are played to accommodate the different bets selected as described in more detail below. Alternatively, there may be special feature events, that are displayed on the secondary display occurring during game play which temporarily replace the pay table information.

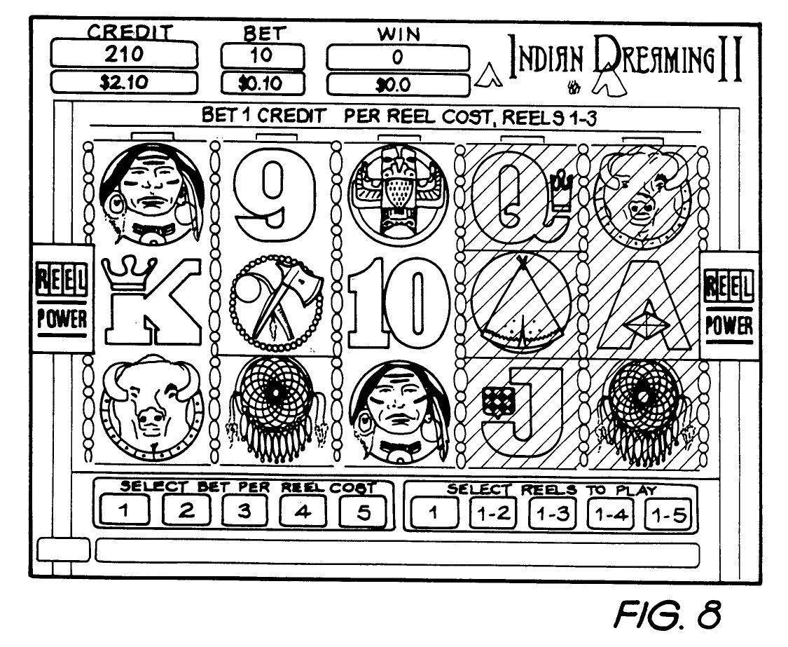

By way of example, if the player touches the one “1c” button in the Indian Dreaming section of the game selection screen shown in FIG. 4, the main display changes to that shown in FIG. 8. Note that the game displayed shows the outcome of the last game of Indian Dreaming that was played on the machine except that the credit meter will display the currently available credit. Hence, in FIG. 8, the credit meter shows $2.10 i.e. 210 credits, which is the same number of credits shown on the game selection screen in FIG. 4. The bet of ten credits represents a bet of one credit per reel cost on three reels at a cost of ten credits (standard reel power bet). The win meter reads zero since there was no winning combination in the last game played.

Note that the gaming machine is arranged so that when the player selects a game denomination e.g. “5c”, if it differs from the last denomination that was played on the machine he will be asked to confirm his selection. For example if a “5c” game is selected after a “1c” game was last played the machine will display “5c game, are you sure? Y/N”

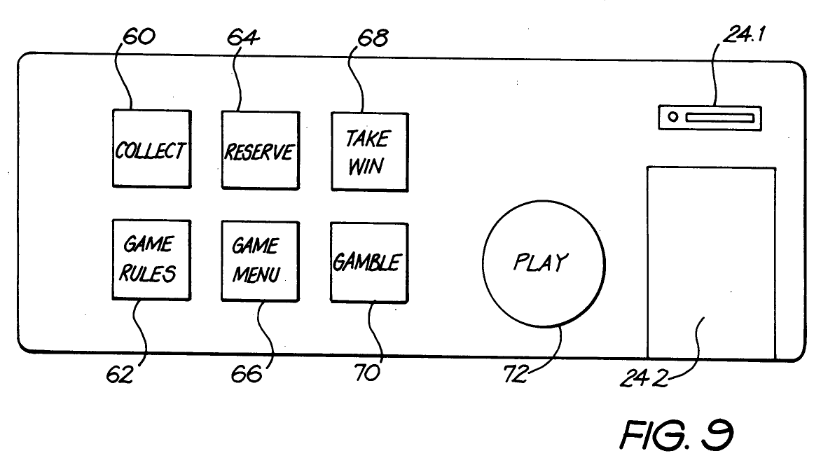

The bet buttons 56 are displayed as touch screen icons on the display screen 14. Since the gaming machine is a multi-game machine, the available buttons may differ for different games and therefore cannot be easily provided using mechanical buttons. In order to prevent the game screen becoming too cluttered, functions that remain consistent in the different games such as PLAY, GAMBLE, TAKE WIN, COLLECT, RESERVE, GAME RULES and GAME MENU, are provided on mechanical buttons 60, 62, 64, 66, 68, 70, and 74 on the mid-trim 20 of the machine as shown in FIG. 9.

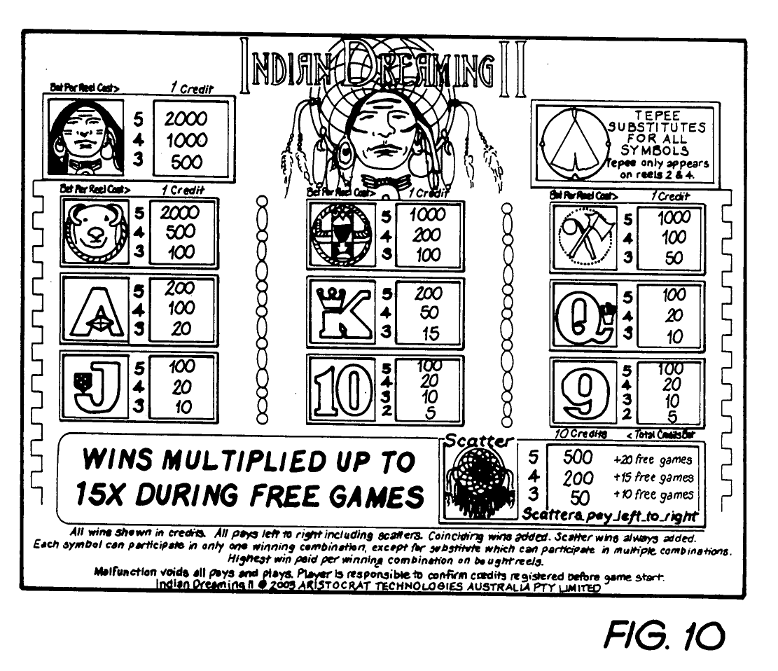

In the preferred embodiment, at the same time as the game screen of FIG. 8 is shown on the main display, the secondary display 28 shows a pay table for the Indian Dreaming game being played along with all essential game information. Whilst this could be all the game information, it is most preferably a subset of the game information, that a player is most likely to want, or need to refer to whilst playing the game. A typical secondary display is shown in FIG. 10.

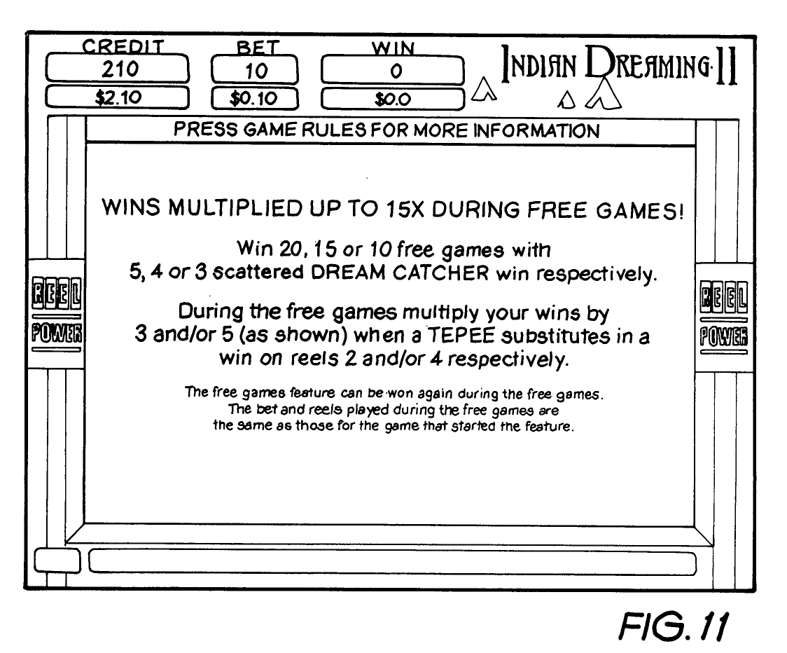

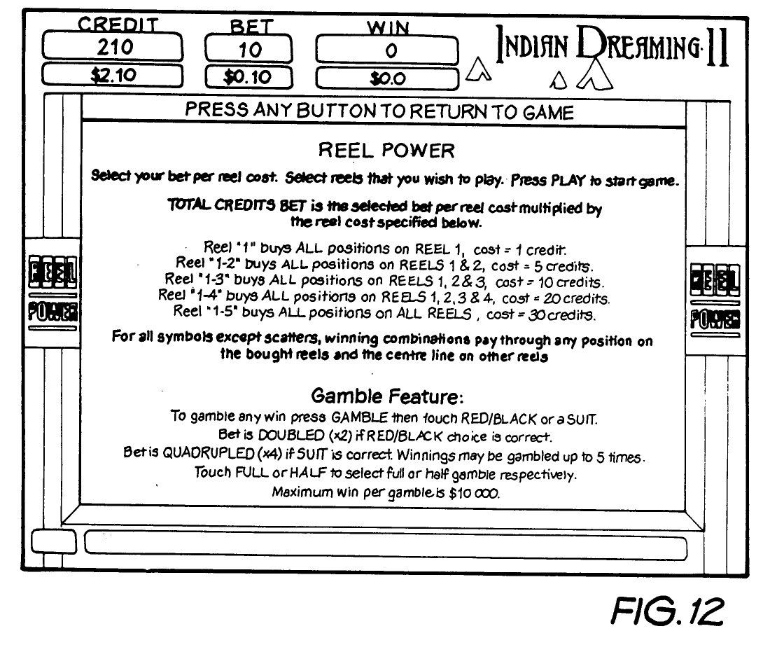

All remaining game information that is not shown on the secondary display, appears on help screens that can be accessed in place of the game screen on the main display 14 in a standard way when the player presses the mechanical GAME RULES button 62. For example, if the player presses the GAME RULES button 62 once, the display shown in FIG. 11 is displayed on the main screen 14. Note that the secondary display shown in FIG. 10 shows that 20, 15, or 10 free games are won when a combination of three or more scatters appears, but if a player wants full details about how the feature functions, they can access the help screen on the main display 14 by pressing button 62 to give them that information which results in the display shown in FIG. 11 being shown on the main screen. When a player has finished reviewing the help screen, they can press any button to exit back to the game screen, or alternatively, can press the GAME RULES button 62 again to view additional rules information such as shown in FIG. 12.

Thus, by providing some information on help screens and other information on the secondary display 28, the player can view necessary game information while playing the game, even for a very complicated game, without the game screen itself 14 becoming cluttered. The players watching the machine will also be able to view a full game package for the game being played in order to understand the game as they watch. This allows observers to identify the games being played by others in order to be able to find the same game elsewhere in the venue if they decide that they wish to play it. The display pay table is also preferably dynamic and as the player selects different bet options, they are reflected on the game screen and secondary display 28 after a new bet is placed.

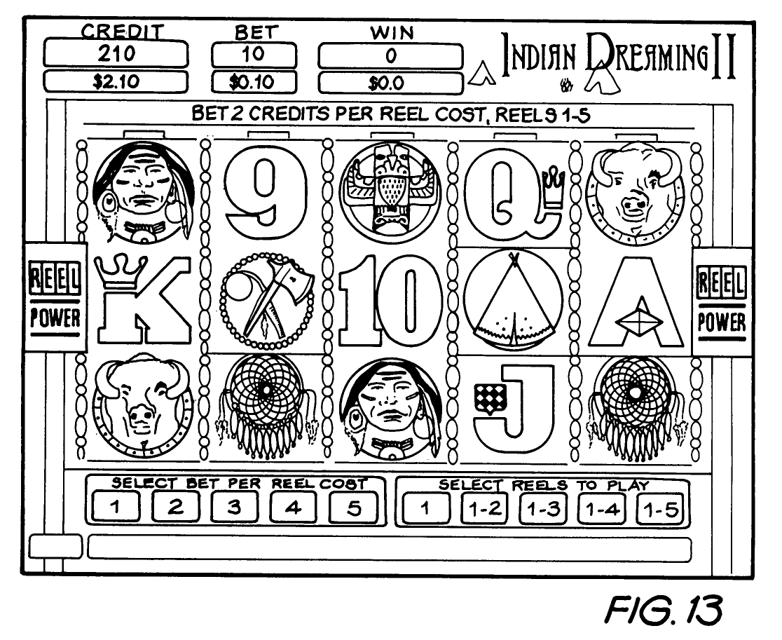

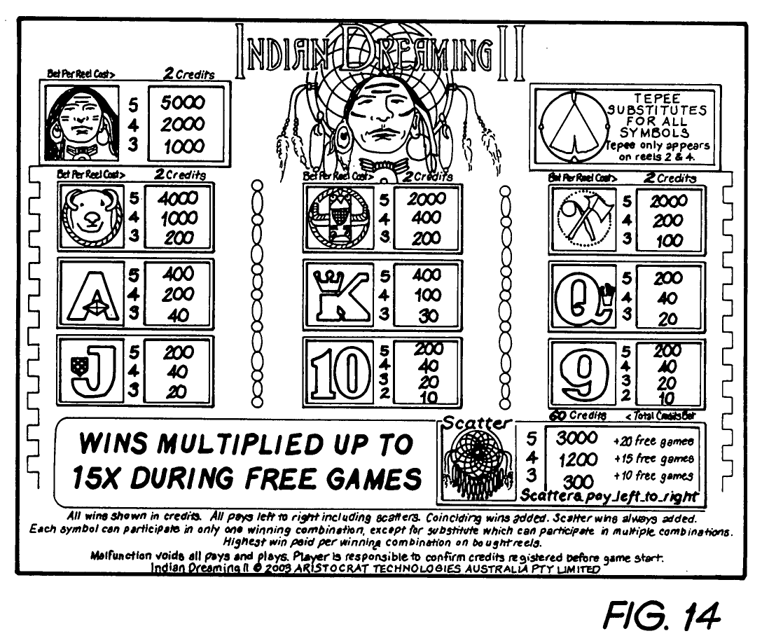

For jurisdictional reasons, the credit bet and win information does not change but for example, if the player were to touch the BET PER REEL COST button 56 displaying the numeral “2” followed by the REELS TO PLAY button 58 labelled “1-5” shown in FIG. 8, the main display will change to that shown in FIG. 13. Note that the reels cost for betting on 1 to 5 reels is thirty credits for the reel power game displayed. At the same time, the secondary display changes to that shown in FIG. 14.

The present invention provides significant advantages over existing multi-gaming machines. It allows individual games accessible within a multi-game gaming machine to be advertised in addition to the multi-game gaming machine itself so that

The games do not lose their identity within the multi-game machine. At the same time, it provides players the ability to view game information whilst playing the game.

It provides a benefit to a venue operator because players know exactly what games are available on a gaming machine embodying the present invention, even from a distance and therefore may be attracted by the machine. the player also benefits since they are allowed to refer to prizes and game information whilst playing the gaming machine which on the secondary display rather than the main game screen where it would clutter up the main game screen and create confusion. A potential player of the game benefits since game information mentioning a game is being displayed so that they can follow what is happening, and know what game is being played and i which game mode the game is being played.

It will be appreciated by persons skilled in the art that numerous variations and/or modifications may be made to the invention as shown in the specific embodiments without departing from the spirit or scope of the invention as broadly described. The present embodiments are, therefore to be considered in all respects as illustrative and not restrictive.

1. A gaming machine including:
a gaming console;
a first display means on which a game can be displayed housed in the console;
a second display means also housed in the console;
a player input means and a control means arranged in the console for controlling images displayed on the first video display means;
wherein the gaming machine is arranged to allow a player to select a game to be played on the gaming machine from a plurality of different games, characterised in that the second display means displays first information when the gaming machine is not being played and/or when no game has been selected, wherein said first information is selected from the group consisting of:
generic information,
information pertaining to multi-game theme, and
advertisements for games playable on the machine displayed together or in sequence one after another; and wherein when a game is selected, or played on the machine, the second display means will display at least second information associated with the selected game, wherein the second information displayed on the second display means is selected from the group consisting of:
an advertisement for the game selected or played on the gaming machine;
a pay table for the game selected or played on the gaming machine;
game information for playing the selected game.

2. A gaming machine as claimed in claim 1 wherein bet buttons are displayed as touch screen icons on the first display means.

3. A gaming machine as claimed in claim 2 wherein functions that remain consistent in the different games including on or more of PLAY, GAMBLE, TAKE WIN, COLLECT, RESERVE, GAME RULES and GAME MENU, are provided on mechanical buttons.

4. A gaming machine including:
a gaming console;
a first display means on which a game can be displayed housed in the console;
a second display means also housed in the console;
a player input means and a control means arranged in the console for controlling images displayed on the first video display means;
wherein the gaming machine is arranged to allow a player to select a game to be played on the gaming machine from a plurality of different games, characterised in that the second display means displays first information when the gaming machine is not being played and/or when no game has been selected, and wherein when a game is selected, or played on the machine, the second display means will display at least second information associated with the selected game.

5. A gaming machine as claimed in claim 4 wherein said first information is selected from the group consisting of:
generic information;
information pertaining to multi-game theme;
advertisements for games playable on the machine displayed together or in sequence one after another.

6. A gaming machine as claimed in claim 4 wherein the second information displayed on the second video display means is selected from the group consisting of:
an advertisement for the game selected or played on the gaming machine;
a pay table for the game selected or played on the gaming machine;
game information for playing the selected game.

7. A gaming machine as claimed in claim 4 wherein the second information displayed on the second display means include a pay table and game information for the selected game.

8. A gaming machine as claimed in claim 7 wherein the pay table and game information for the selected game remain on the second display means for the duration of play of the selected game.

9. A gaming machine as claimed in claim 7 wherein the gaming machine is arranged to display special feature events on the second display means occurring during game play which temporarily replace the pay table and game information.

10. A gaming machine as claimed in claim 4 wherein bet buttons are displayed as touch screen icons on the first display means.

11. A gaming machine as claimed in claim 4 wherein functions that remain consistent in the different games including one or more of PLAY, GAMBLE, TAKE WIN, COLLECT, RESERVE, GAME RULES and GAME MENU, are provided on mechanical buttons.

12. A gaming machine as claimed in claim 10 wherein functions that remain consistent when different games are played on the gaming machine including one or more of PLAY, GAMBLE, TAKE WIN, COLLECT, RESERVE, GAME RULES and GAME MENU, are provided on mechanical buttons.

13. A gaming machine as claimed in claim 12 wherein the gaming machine console defines a mid-trim on which the mechanical buttons are located.

14. A gaming machine as claimed in claim 7 wherein the prizes of the pay table of the selected game change to reflect the amount bet whenever a player selects new bet amounts.

15. A gaming machine as claimed in claim 4 wherein the gaming machine is arranged so that the player selects a game to play by touching the first display means.

16. A gaming machine as claimed in claim 15 wherein multiple denominations of one or more games are displayed on the first display means.

17. A gaming machine as claimed in claim 16 wherein the gaming machine is arranged such that if the player selects a game denomination which differs from the last denomination that was played on the gaming machine the machine requests confirmation of that selection.

18. A gaming machine including:
a gaming console defining;
a first display means on which a game can be displayed housed in the console;
a second display means also housed in the console; and
a mid trim; the gaming machine including
a player input means and a control means arranged in the console for controlling images displayed on the first video display means;
wherein the gaming machine is arranged to allow a player to select a game to be played on the gaming machine from a plurality of different games, characterised in that the second display means displays first information when the gaming machine is not being played and/or when no game has been selected, wherein said first information is selected from the group consisting of:
generic information,
information pertaining to multi-game theme, and
advertisements for games playable on the machine displayed together or in sequence one after another; and
wherein when a game is selected, or played on the machine, the second video display means will display at least second information associated with the selected game, wherein the second information displayed on the second video display means is selected from the group consisting of:
an advertisement for the game selected or played on the gaming machine;
a pay table for the game selected or played on the gaming machine;
game information for playing the selected game.
and wherein touch screen bet selection buttons are provided on the first display means and prizes of the pay table of the selected game change to reflect the amount bet whenever a player selects new bet amounts.
